(19) United States
(12) Patent Application Publication
(10) Pub. No.: US 2022/0092107 A1
(43) Pub. Date: Mar. 24, 2022

(54) METHOD AND APPARATUS FOR PERFORMING ALBUM MANAGEMENT REGARDING EXTERNAL STORAGE DEVICE FOR USER

(71) Applicant: JMicron Technology Corp., Hsinchu County (TW)

(72) Inventors: Chao-Yin Liu, Hsinchu City (TW); Chih-Yi Chiang, Hsinchu City (TW)

(21) Appl. No.: 17/148,527

(22) Filed: Jan. 13, 2021

(30) Foreign Application Priority Data
Sep. 22, 2020 (TW) 109132664

(51) Int. Cl. G06F 16/55; G06F 16/58; G06F 16/587; G06F 16/51

(52) U.S. Cl. CPC G06F 16/55; G06F 16/51; G06F 16/587; G06F 16/5866

(57) ABSTRACT

A method and apparatus for performing album management regarding an external storage device for a user are provided. The external storage device is positioned outside of an electronic device and is coupled to the electronic device to be an accessory of the electronic device. The method may include: utilizing a processing circuit of the electronic device to scan all pictures of multiple pictures in at least one internal storage device within the electronic device and analyze respective picture contents of the multiple pictures to perform classification, and establish an index database of each picture of the multiple pictures according to multiple classification tags respectively corresponding to multiple types of classification; and utilizing the processing circuit to control at least two stages of backup, to generate multiple classified albums respectively corresponding to the multiple types of classification within the external storage device.

### BACKGROUND OF THE INVENTION

### 1. Field of the Invention

The present invention relates to an accessory of mobile phone, and more particularly, to a method and apparatus for performing album management regarding an external storage device for a user. For example, the user can directly browse the classified-contents backup albums in the external storage device with operating systems of other electronic devices. Examples of the aforementioned other electronic devices may include, but are not limited to, a personal computer, a mobile phone, a digital television (TV), a digital picture frame, and so on.

### 2. Description of the Prior Art

In a mobile phone of various multifunctional mobile phones, pictures taken by the mobile phone can be stored in a non-volatile (NV) memory of the mobile phone, and a media browser in the mobile phone can automatically display base on time, place, or some object classifications related to person, pets, etc., for a user to browse. However, certain problems may occur. For example, when a user backs up these pictures to an external storage device, the user cannot utilize the automatic classification results. For another example, the user can create a classified album on the mobile phone, but after the user backs up the pictures to the external storage device, the user cannot browse the classified album on the external storage device. Regarding any of these examples, the user may try to redesign the classification way and manually create the album directory on the external storage device, which may cause additional problems. Since there are file system design limitations, each picture in the external storage device can only be classified in one way. For example, when users manually classify picture albums by time, they cannot see classifications based on events, objects, etc. In addition, although there are backup results, the user is forced to manually classify the pictures again. This kind of backup result is meaningless to users, because the pictures that have been properly organized need to be rearranged and classified after backup, as if they were thrown directly into a trash can.

Some solutions in the related art are provided to try to solve the above-mentioned problems, but there may be some other problems. For example, some specially designed software can be used to back up pictures on personal computers and browse backed up pictures. However, in a typical operating system, users cannot use a basic management program such as File Explorer to browse classified result in an external storage device. In addition, some solutions cannot perform multiple types of classification for a picture, and more particularly, cannot achieve complicated classification such as travel memories of a same place over the years, or travel memories of multiple scenic spots on a same day, etc. These solutions have a common problem: after backup of pictures, users cannot directly browse the classified pictures in a typical operating system environment. Therefore, there is a need for a novel method and associated architecture to implement an electronic device equipped with a proper album management mechanism without introducing side effects or in a way that is less likely to introduce a side effect.

### SUMMARY OF THE INVENTION

It is an objective of the present invention to provide a method and apparatus for performing album management regarding an external storage device for a user, such that the user can directly browse classified results in the external storage device within a typical operating system, for example, by using a basic management program such as File Explorer to browse pictures indifferent classifications, and bring an excellent experience to users.

At least one embodiment of the present invention provides a method for performing album management regarding an external storage device for a user, applicable to an electronic system. The electronic system comprises an electronic device and the external storage device. The external storage device is positioned outside of the electronic device and coupled to the electronic device as an accessory of the electronic device. The method comprises: utilizing a processing circuit to control at least two stages of backup, to generate a plurality of classified albums respectively corresponding to multiple types of classification within the external storage device. For example, operations of the at least two stages of backup may comprise: regarding a first-stage backup, creating a first physical classified album among the plurality of classified albums according to a first type of classification index; and regarding a second-stage backup, creating at least one other classified album among the plurality of classified albums according to at least one other type of classification index, wherein said at least one other classified album is different from the first physical classified album, and said at least one other classified album has reference information of at least one portion of pictures in the first physical classified album, to allow the user to directly browse all classified albums of the plurality of classified albums through an operating system.

At least one embodiment of the present invention provides an apparatus for performing album management regarding an external storage device for a user. The apparatus comprises an electronic device. The electronic device comprises a processing circuit, at least one internal storage device and an interface circuit. The processing circuit is configured to execute a program code to control operations of the electronic device. The at least one internal storage device is coupled to the processing circuit and configured to store information for the electronic device. The interface circuit is coupled to the processing circuit, and is configured to perform communications, wherein the external storage device is coupled to the electronic device through the interface circuit to be an accessory of the electronic device. The processing circuit controls at least two stages of backup, to generate a plurality of classified albums respectively corresponding to multiple types of classification within the external storage device. For example, operations of said at least two stages of backup may comprise: regarding a first-stage backup, creating a first physical classified album among the plurality of classified albums according to a first type of classification index; and regarding a second-stage backup, creating at least one other classified album among the plurality of classified albums according to at least one other type of classification index, wherein said at least one other classified album is different from the first physical classified album, and said at least one other classified album has reference information of at least one portion of pictures in the first physical classified album, to allow the user to directly browse all the classified albums of the plurality of classified albums through an operating system.

The method and apparatus of the present invention can first establish classification index information related to files such as pictures, videos, etc., and, regarding file systems such as File Allocation Table (FAT), NT File System (NTFS), etc., utilize special design to back up classified pictures to an external storage device, to allow users to directly browse the classified results in the external storage device in a typical operating system, for example, to browse pictures indifferent classification themes by using a basic management program such as File Explorer, having no need to use a specially programed software to browse the classification results. Therefore, the present invention can improve the overall performance without introducing side effects or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for performing album management regarding an external storage device for a user according to an embodiment of the present invention.

FIG. 2 is a flowchart illustrating a method for performing album management regarding an external storage device for a user according to an embodiment of the present invention.

FIG. 3 is a diagram illustrating an example of multiple types of classification involved in the method shown in FIG. 2.

FIG. 4 is a diagram illustrating another example of multiple types of classification involved in the method shown in FIG. 2.

### DETAILED DESCRIPTION

One or more embodiments of the present invention indicate that the method and apparatus of the present invention can break through the bottleneck of a single type of classification when performing backup. In a backup destination device, the single type of classification brings certain limitations, and more particularly, regarding the design of a tree-like file system, the directory name merely corresponds to the single type of classification, for example, when the time is emphasized, a new directory is created with a name of date/time such as year, month, day, etc. to store the corresponding pictures respectively, or when the place is emphasized, a new directory is created with a name of place to store the corresponding pictures respectively, or when the event is emphasized, a new directory is created with a name of event (such as New Year's Eve fireworks) to store the corresponding pictures respectively. When a picture has various information (corresponding to time, place, event, person, object, etc.), the picture is merely put in a single type of album. Therefore, there is a lack of other types of classification in the backup destination device. The method and apparatus of the present invention can simultaneously manage multiple types of classification when performing backup, to make the respective directory names of multiple sets of directories in an external storage device correspond to the multiple types of classifications, respectively, for example, control the above operation as follows:

(1) when time is used as a first type of classification, creating a first set of directories with respective date/time names such as year, month, day, etc. for storing pictures corresponding to different dates/times (e.g., the picture files of these pictures), respectively;

(2) when a place is used as a second type of classification, creating a second set of directories with respective place names for storing pictures corresponding to different places (e.g., reference information of the picture files of these pictures), respectively; and

(3) when an event is used as a third type of classification, creating a third set of directories with respective event names (such as New Year's Eve fireworks) for storing pictures corresponding to different events (e.g., reference information of the picture files of these pictures), respectively.

In particular, by setting reference information regarding at least one portion of directories (e.g., a portion of directories or all directories) among the multiple sets of directories, the method and apparatus of the present invention can maintain the multiple types of classifications to make them exist at the same time, to improve the overall performance without introducing side effects or in away that is less likely to introduce a side effect, and to provide an excellent experience to users.

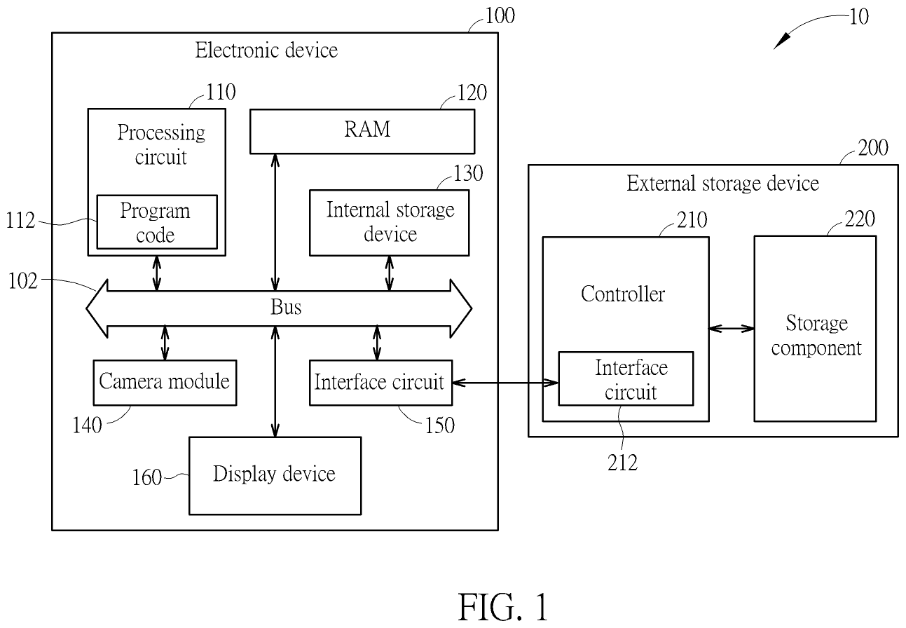

FIG. 1 is a diagram illustrating an apparatus for performing album management regarding an external storage device for a user according to an embodiment of the present invention, where the apparatus may comprise at least one portion (e.g. a portion or all) of an electronic system 10, such as an electronic device 100 and/or an external storage device 200 of the electronic system 10. The electronic device 100 may comprise a processing circuit 110 and a random access memory (RAM) 120, and comprise at least one internal storage device (e.g. one or more internal storage devices), which may be collectively referred to as the internal storage device 130, and further comprise a camera module 140, an interface circuit 150 and a display device 160, where the above components can be coupled to each other through a bus 102, but the invention is not limited thereto. The external storage device 200 may comprise a controller 210 and a storage component 220, and an interface circuit 212 may be integrated into the controller 210 as a built-in component within the controller 210. The processing circuit 110 can execute a program code 112 to control the operations of the electronic device 100. Under the control of the processing circuit 110 running the program code 112, the camera module 140 can perform image-capturing operations to generate user data related to images, such as pictures, videos, etc., and the internal storage device 130 can store information for the electronic device 100, and more particularly, store the user data such as these pictures, videos, etc., and the display device 160 can display information, and more particularly, display the user data such as these pictures, videos, etc., where the RAM 120 can temporarily store information and can be used as a data buffer, and the interface circuit 150 may conform to at least one specific communications specification such as Universal Serial Bus (USB) specification, Serial Advanced Technology Attachment (SATA) specification, external SATA (eSATA) specification, etc., for coupling the external storage device 200 to the processing circuit 110, and more particularly, communicate with the external storage device 200 for the electronic device 100 to perform data transmission between the electronic device 100 and the external storage device 200. In addition, the controller 210 can control the operations of the external storage device 200. Under the control of the controller 210, the storage component 220 can store information for the electronic device 100, and more particularly, backup the user data in the electronic device 100, such as these pictures, videos, etc., where the interface circuit 212 may conform the specific communications specification, for coupling the controller 210 to the electronic device 100, and more particularly, communicate with the electronic device 100 for the external storage device 200 to perform data transmission between the electronic device 100 and the external storage device 200. Examples of the electronic device 100 may include (but are not limited to): a multifunctional mobile phone, a personal computer such as a laptop computer, an all-in-one computer, etc. Examples of the external storage device 200 may include (but are not limited to): a hard disk drive, a solid state drive, a flash drive (e.g. USB flash drive), a bridge device, etc.

In the above embodiment, the processing circuit 110 can be implemented by way of a processor or the like, the program code 112 can be implemented by way of an operating system, one or more drivers, one or more applications, etc., the RAM 120 can be implemented by way of a dynamic random access memory, etc., the internal storage device 130 can be implemented by way of a non-volatile memory such as a flash memory, and the display device 160 can be implemented by way of a monitor (e.g. a liquid crystal display, an organic light-emitting diode (OLED) display, etc.), touch screen and so on. In addition, the controller 210 can be implemented by way of a microprocessor, logic circuits, etc., and the storage component 220 can be implemented by way of a non-volatile memory such as a flash memory. Furthermore, when the external storage device 200 represents the bridge device, the storage component 220 may represent a memory card.

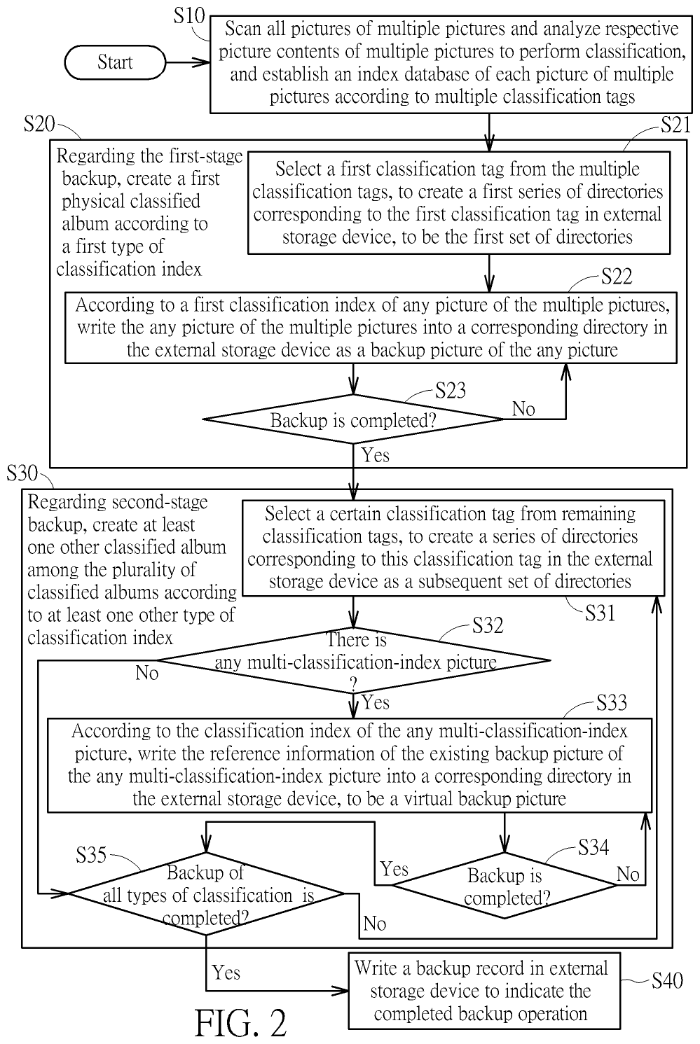

FIG. 2 is a flowchart illustrating a method for performing album management (e.g., classified-contents backup, such as the backup corresponding to the multiple types of classification) regarding an external storage device for a user according to an embodiment of the present invention, where the method can be applied to the apparatus, and more particularly, the architecture shown in FIG. 1). Under the control of the processing circuit 110 executing the program code 112, the electronic device 100 can operate according to the method.

In Step S10, the processing circuit 110 can scan (for example, read one by one) all pictures of multiple pictures in the electronic device 100 and analyze the respective picture contents of the multiple pictures to perform classification, and establish an index database of each picture of the multiple pictures according to multiple classification tags (e.g., time tag “time”, place tag “place”, event tag “event”, person tag “person”, object tag “object”, user-defined category tag “category #1”, etc.) respectively corresponding to the multiple types of classification (e.g., time, place, event, person, object, user-defined category such as category #1, etc.), where the index database may comprise one or more classification indexes of each picture, to indicate that said each picture is classifiable to one or more corresponding types of classification among the multiple types of classification. For better comprehension, the above tags in bold can be displayed on the display device 160, for the user to identify classified albums corresponding to the multiple types of classification, and to arbitrarily switch album among the classified albums, but the invention is not limited thereto.

For example, the multiple pictures can be stored in the internal storage device 130. The processing circuit 110 can first perform automatic classification on the above-mentioned all pictures in the electronic device 100 (e.g. automatically classify these pictures) according to time, place, event, person, object, user-defined category such as category #1, etc., to create multiple types of classified albums corresponding to the multiple types of classification (e.g., time, place, event, person, object, user-defined category such as category #1, etc.) respectively, to be the classified albums in the electronic device 100, and collect multiple classification indexes respectively corresponding to the multiple types of classifications during the automatic classification, so as to create respective index databases of the multiple pictures according to these classification indexes, for use when performing backup. The operations of the automatic classification may comprise: reading the exchangeable image file format (EXIF) information automatically generated when the picture is taken, to classify with respect to time, place, etc., where the EXIF information may comprise time, place and camera type, etc.; utilizing machine learning technology to recognize faces and objects (e.g., food, vehicles, pets such as cats, dogs, etc.); and identifying image event information according to picture contents. Since performing the automatic classification operations by analyzing the picture contents is known to those skilled in the art, further details are omitted here for brevity.

According to the present embodiment, after completing establishing the index database of said each picture, the processing circuit 110 can start performing the classified-contents backup, in particular, control at least two stages of backup such as a first stage of backup and a second stage of backup, which can be respectively referred to as a first-stage backup and a second-stage backup hereinafter for brevity, to generate a plurality of classified albums respectively corresponding to the multiple types of classification within the external storage device 200, where the operations of the at least two stages of backup may comprise subsequent steps in the working flow shown in FIG. 2.

In Step S20, regarding the first-stage backup, the processing circuit 110 can create a first physical classified album among the plurality of classified albums according to a first type of classification index (which may correspond to a first type classification among the multiple types of classification, such as time), where the first physical classified album in the external storage device 200 may comprise respective backup pictures of the multiple pictures in the electronic device 100. For example, Step S20 may comprise multiple sub-steps such as Steps S21 to S23. The term “physical” of the first physical classified album means that the first physical classified album contains the respective physical data files of these backup pictures, such as files with the physical data of these backup pictures, and these backup pictures can be regarded as physical backup pictures. For example, this classified album is the first and the only classified album created by the processing circuit 110 during the first-stage backup. During the first-stage backup, the processing circuit 110 can back up/copy the picture files of the multiple pictures to the external storage device 200 as these backup pictures and create this classified album, in particular, generate the corresponding directory name and directory contents such as multiple directory entries respectively corresponding to these backup pictures. This classified album is the first and the only classified album of this stage of backup and comprises the above-mentioned physical data files, and therefore can be referred to as the first physical classified album. In comparison with this, during the second-stage backup, the processing circuit 110 creates subsequent classified album(s) but does not back up/copy/move any actual files of these picture files to the external storage device 200, and therefore the subsequent classified album(s) can be referred to as logical classified album(s).

In Step S21, the processing circuit 110 can select a first classification tag (e.g., time tag “time”) corresponding to the first type of classification (e.g., time) from the multiple classification tags (e.g., time tag “time”, place tag “place”, event tag “event”, person tag “person”, object tag “object”, user-defined category tag “category #1”, etc.) respectively corresponding to the multiple types of classification (e.g., time, place, event, person, object, user-defined category such as category #1, etc.), to create a first series of directories corresponding to the first classification tag (e.g., a series of directories corresponding to the time tag “time”, such as 201807, 20191010, etc.) in the external storage device 200, to be the first set of directories.

In Step S22, according to a first classification index of any picture of the multiple pictures, such as a classification index (e.g., time index) corresponding to the first type of classification (e.g., time), the processing circuit 110 can write the any picture of the multiple pictures into a corresponding directory (for example, a directory corresponding to a certain time point) in the external storage device 200 as a backup picture of the any picture in the external storage device 200.

In Step S23, regarding the first classification tag (e.g., time tag “time”) corresponding to the first type of classification (e.g., time), the processing circuit 110 can check whether backing up the above-mentioned all pictures of the multiple pictures is completed. If Yes, Step S30 is entered; if No, Step S22 is entered to perform a backup operation of a next picture. For example, the above-mentioned all pictures of the multiple pictures respectively have their own first classification indexes, such as respective classification indexes (e.g., time indexes) corresponding to the first type of classification (e.g., time). By performing the operation of Step S22 multiple times, the processing circuit 110 can complete the backup of the above-mentioned all pictures of the multiple pictures.

According to this embodiment, the time and the time tag “time” can be taken as examples of the first type of classification and the first classification tag, respectively. In this situation, the processing circuit 110 may first create directories having directory names (e.g., 201807, 20191010, etc.) related to the time indexes in the file system of the external storage device 200 as the first set of directories according to the time sequence, to generate the first physical classified album such as a time classification album, and then write the above-mentioned all pictures according to classification results (e.g., the respective capturing time thereof, such as the time intervals when these pictures are taken) indicated by the time indexes thereof into corresponding directories in the external storage device 200 respectively. After completing the backup of the above-mentioned all pictures regarding the first type of classification, the processing circuit 110 can perform the second-stage backup.

In Step S30, regarding the second-stage backup, the processing circuit 110 can create at least one other classified album among the plurality of classified albums according to at least one other type of classification index (which may correspond to at least one other type of classification among the multiple types of classification, such as at least one of place, event, person, object, user-defined category, etc.), where the at least one other classified album is different from the first physical classified album, and the at least one other classified album has reference information of at least one portion of pictures (e.g. a portion of pictures or all pictures) in the first physical classified album, to allow the user to directly browse all classified albums of the plurality of classified albums through an operating system (e.g., the operating system of the electronic device 100). In particular, any classified album of the at least one other classified album in the external storage device 200 may have reference information of one or more pictures in the first physical classified album to indicate the one or more pictures shared by the any classified album, to allow the user to directly browse all classified albums of the plurality of classified albums through the operating system. For example, Step S30 may comprise multiple sub-steps such as Steps S31 to S35.

According to this embodiment, a file system of the external storage device 200 can be equipped with a hard link function or a soft link function, where the reference information of the at least one portion of pictures in the first physical classified album can be generated based on the hard link or soft link function, but the present invention is not limited thereto. In some embodiments, the file system (e.g., FAT/Extensible FAT (exFAT) file system) of the external storage device 200 is not equipped with the above-mentioned hard link or soft link function, where the reference information of the at least one portion of pictures in the first physical classified album can be generated by changing an indicator of directory structure. Therefore, no matter what type of file system the file system is, in a situation where the reference information is used, any classified album of the at least one other classified album in the external storage device 200 does not need to have a duplicate of the same picture file content as the first physical classified album, and more particularly, does not have a duplicate of the same file content as the first physical classified album. As a result, any file content (e.g. picture file content) of any file (e.g. picture file) in the first physical classified album will not be found in the any classified album.

In Step S31, the processing circuit 110 can select a certain classification tag (e.g., one of place tag “place”, event tag “event”, person tag “person”, object tag “Object”, user-defined category tag “category #1”, etc.) corresponding to a certain type of classification (e.g., one of place, event, person, object, user-defined category, etc.) from one or more remaining classification tags (e.g., one or more classification tags that have not been selected in the working flow shown in FIG. 2) among the multiple classification tags, to create a series of directories (for example, a series of directories corresponding to the place tag “place”, such as Taipei City, Hualien, Tokyo, etc.; for another example, a series of directories corresponding to the object tag “object”, such as cats, dogs, sports cars, etc.) corresponding to this classification tag in the external storage device 200 as a subsequent set of directories, such as one set of directories among the second set of directories, the third set of directories, etc.

In Step S32, the processing circuit 110 can check whether there is any multi-classification-index picture with a classification index (e.g., one of the place index, event index, person index, object index, category #1 index, etc. respectively corresponding to place, event, person, object, category #1, etc.) corresponding to this classification tag (just selected in Step S31) among the multiple pictures. If Yes, Step S33 is entered; if No, Step S35 is entered.

In Step S33, the processing circuit 110 can write the reference information of the existing backup picture of the any multi-classification-index picture into a corresponding directory (e.g., one of a directory corresponding to a certain place, a directory corresponding to a certain event, a directory corresponding to a certain person, a directory corresponding to a certain object, a directory corresponding to category #1, etc.) in the external storage device 200 according to the classification index of the any multi-classification-index picture, to be a virtual backup picture (e.g. a logical backup picture) of the any multi-classification-index picture in the external storage device 200, where the reference information of the existing backup picture typically points toward the existing backup picture, which is a certain backup picture written into the external storage device 200 during the first-stage backup, such as one of the above-mentioned physical backup pictures. For example, the reference information of the existing backup picture can be implemented by ways of hard link, soft link, etc. For another example, in a situation where the file system of the external storage device 200 is a FAT/exFAT file system, the processing circuit 110 can write associated information (e.g. the file name, etc.) of the existing backup picture into the directory structure of this directory (e.g., a certain directory entry, which can be used for representing a certain file belonging to this directory), and fill in the field “FirstCluster” to point to an address of the existing backup picture. According to some viewpoints, since the processing circuit 110 uses the reference information (rather than any physical data file) of the existing backup picture to represent the backup version of the multi-classification-index picture in this directory, this reference information can be regarded as a virtual backup picture (e.g. a logical backup picture).

In Step S34, regarding the current classification tag (e.g., one of the place tag “place”, event tag “event”, person tag “person”, object tag “object”, user-defined category tag “category #1”, etc.) corresponding to the current type of classification (e.g., one of place, event, person, object, user-defined category, etc.), the processing circuit 110 can check whether the backup of all associated multi-classification-index pictures among the multiple pictures is completed. If Yes, Step S35 is entered; if No, Step S33 is entered to back up the next associated multi-classification-index picture.

In Step S35, the processing circuit 110 can check whether the backup of the associated multi-classification-index pictures of all types of classification is completed. If Yes, Step S40 is entered; if No, Step S31 is entered to back up the associated multi-classification-index pictures of the next type of classification.

For example, when selecting a second classification tag, such as the place tag “place”, the processing circuit 110 can create a second type of classification directories (e.g., using a place name or a landmark as the directory name of any of these directories) in the external storage device 200, and find the pictures of each place according to the classification index representing said each place. Since these pictures have been written into the external storage device 200 during the first-stage backup as physical backup pictures, the processing circuit 110 can write respective reference information of the physical backup pictures in the place directory corresponding to said each place among these directories according to these classification indexes, to be virtual backup pictures (e.g. logical backup pictures), and there is no need to write the picture files in the external storage device 200 again. Afterward, the processing circuit 110 can perform similar processing on a third classification tag, a fourth classification tag, etc. respectively.

In Step S40, after writing the physical/virtual backup pictures of all classification tags of the multiple classification tags into the corresponding directories in the external storage device 200, the processing circuit 110 can write a backup record in the external storage device 200 to indicate the completed backup operation for reference when performing a differential backup in the future.

After the classified-contents backup is completed, when coupling the external storage device 200 to the above-mentioned other electronic devices such as any typical personal computer, the user can use the file management tool (e.g. File Explorer, etc.) of the operating system of this computer to browse the picture albums corresponding to the multiple types of classification in the external storage device 200, having no need to install any additional application programs. Since there is only one set of physical files (rather than any duplicate thereof), the storage space of the external storage device 200 will not be wasted.

TABLE 1

| Name | Description |
|---|---|
| DIR_Name | Short file name |
| DIR_Attr | File attributes |
| DIR_NTRes | Reserved |
| DIR_CrtTimeTenth | Millisecond stamp at file creation |
| DIR_CrtTime | Time file was created |
| DIR_CrtDate | Date file was created |
| DIR_LstAccDate | Last access date |
| DIR_FirstClusterHI | High word of this entry's first cluster |
| | number |
| DIR_WrtTime | Time of last write |
| DIR_WrtDate | Date of last write |
| DIR_FirstClusterLO | Low word of this entry's first cluster |
| | number |
| DIR_FileSize | This file's size in bytes |

Table 1 shows an example of the FAT32 Directory Entry Structure, where “Name” and “Description” in Table 1 list multiple fields in the structure of a certain directory entry and their meanings, respectively. For example, the above-mentioned field “FirstCluster” may comprise “DIR_FirstClusterHI” and “DIR_FirstClusterLO” shown in Table 1.

For better comprehension, exFAT Directory Entry may comprise three important entry types:

(1) File and directory: file attribute and timestamp;
(2) Stream extension: file allocation information;
(3) File name: name of the file.

TABLE 2

| Field name | Description |
|---|---|
| EntryType | 0xC0 (Stream extension entry) |
| GeneralSecondaryFlags | Status of the file allocation |
| Reserved1 | (Reserved) |
| NameLength | Length of the file name, measured |
| | in UTF16 encoding unit |
| NameHash | 16-bit checksum of the file name |
| Reserved2 | (Reserved) |
| ValidDataLength | Valid data length of the file, |
| | measured in bytes |
| Reserved3 | (Reserved) |
| FirstCluster | First cluster number of cluster chain |
| DataLength | Actual length of the file in bytes |

Table 2 shows an example of the Stream Extension Entry Structure, where “Field Name” and “Description” in Table 2 list multiple fields in the structure of a certain stream extension entry and their meanings, respectively. For example, the above-mentioned field “FirstCluster” may comprise “FirstCluster” shown in Table 2.

Some implementation details regarding the classified-contents backup can be further described as follows. According to some embodiments, as the FAT/exFAT file system does not support the hard link/soft link function, the processing circuit 110 can generate the reference information of the existing backup picture based on the characteristics of the FAT directory structure (e.g. the directory entry structure of Table 1)/exFAT directory structure (e.g. the stream extension entry structure of Table 2). The processing circuit 110 can record related information about a file (e.g. a picture file), such as the file name, attribute, size, the actual address of the location where it is stored in the external storage device 200, etc., into a certain directory entry in the directory structure of the FAT/exFAT file system, wherein the common field “FirstCluster” is used for defining the actual address where this file is stored in the storage device. Therefore, when the file of the existing backup picture exists in the external storage device 200, the processing circuit 110 can obtain the physical address of the location where this file is stored in the external storage device 200, and fill this address into the field “FirstCluster” in the directory entry structure as the reference information, to make the operating system be capable of reading the directory and reading the file content according to the FAT/exFAT structure, allowing users to browse freely in this environment without hindrance. Please note that modifying the field “FirstCluster” to generate the reference information is suitable for the reading behavior of the operating system, and does not conform to the hard link/soft link operation, and therefore it is very useful for the implementation of the present invention, where the apparatus of the present invention can use a specially designed program corresponding to the method to write the backup pictures into the external storage device 200 instead of using the writing operation of the operating system. Assuming that implementing the soft link on the FAT file system is adopted, this will make the designer be forced to modify the driver of the original operating system, and therefore is not as good as the method of the present invention. The method of the present invention does not need to modify the operating system, and the processing circuit 110 can read the files in this directory under the environment of the original operating system.

For example, assuming that a user uses the electronic device 100 such as the multifunctional mobile phone to take pictures of Taipei New Year's Eve and the flag-raising pictures of the Presidential Palace from Dec. 31, 2019 to Jan. 1, 2020, and organizes the pictures in the albums of the multifunctional mobile phone by himself/herself, and more particularly, creates at least two directories such as “/New Year's Eve Fireworks”, “/Honor Guard Performance”, etc. for respectively storing fireworks pictures, honor guard performance pictures, etc. The processing circuit 110 can back up these pictures to the external storage device 200 according to the method of the present invention. For example, the external storage device 200 uses a standard file system such as FAT/NTFS. During the first-stage backup, the processing circuit 110 can first create a series of directories “/20191231”, “/20200101”, etc. (which can be regarded as physical directories or physical albums) corresponding to the time tag “time” in the external storage device 200, and then write all the pictures taken in these two days into these directories, respectively (e.g., copy the picture files from the internal storage device 130 to the external storage device 200, and make the directory contents of these directories point to the addresses of these pictures in the external storage device 200). In the first round of operations during the second-stage backup, the processing circuit 110 may create a series of directories “/Municipal Square”, “/Presidential Palace”, etc. (which can be regarded as logical directories or logical albums) corresponding to the place tag “place” in the external storage device 200, and then write the reference information of the existing backup pictures of the associated pictures into the directory contents of these directories, respectively. Since these existing backup pictures exist in the external storage device 200, the processing circuit 110 can fill in the addresses of these existing backup pictures in the external storage device 200 into these directories, respectively, for example, by using the hard links/soft links provided by the file system, or by filling in the FAT directory structure, as described above. In the second round of operations during the second-stage backup, the processing circuit 110 may create a series of directories corresponding to user-defined category/categories in the external storage device 200, such as at least two directories that are the same as the above-mentioned at least two directories created by the user in the internal storage device 130, e.g., “/New Year's Eve Fireworks”, “/Honor Guard Performance”, etc. in the external storage device 200, and, in a manner similar to that of the first round of operations, write the reference information of the existing backup pictures of the associated pictures into the directory contents of these directories, respectively (e.g., write the addresses of the firework pictures in the external storage device 200 into the directory “/New Year's Eve Fireworks”, and write the addresses of the honor guard performance pictures in the external storage device 200 into the directory “/Honor Guard Performance”). When the processing circuit 110 successfully creates respective series of directories corresponding to all the classification tags and writes the corresponding directory contents in the external storage device 200, the processing circuit 110 completes the classified-contents backup. When the user couples the external storage device 200 to the above-mentioned other electronic devices such as the any typical personal computer, since these classified directories and contents are created based on the standard file system, the user can use the file management tool of the computer's operating system (e.g. File Explorer, etc.) to browse the albums respectively corresponding to the multiple types of classifications in the external storage device 200. In response to the classification ways that are organized by the user on the multifunctional mobile phone, the processing circuit 110 can make the albums on the external storage device 200 be organized in the same classification ways, as will be seen by the user when the user browse these albums with the above-mentioned other electronic devices such as the any typical personal computer.

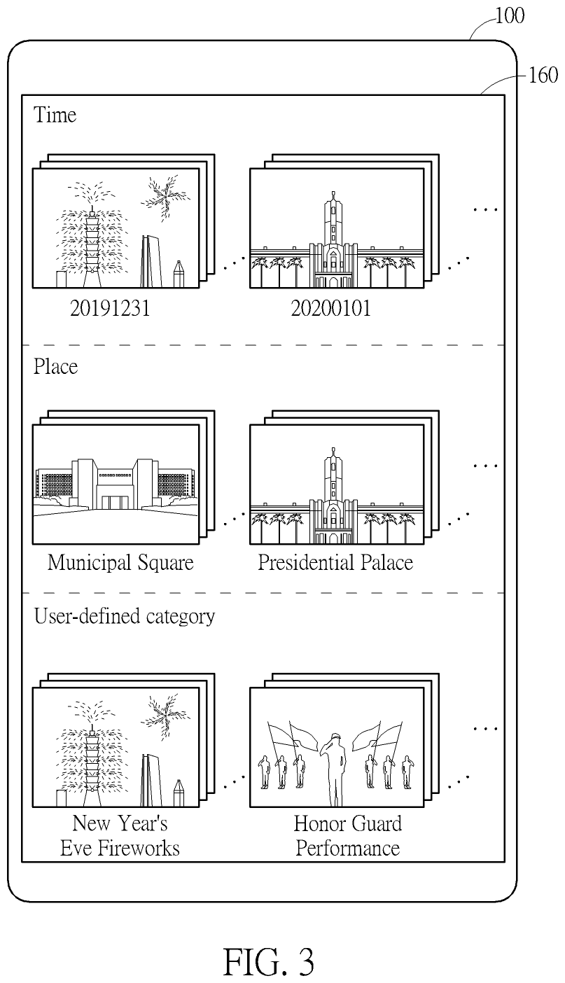

FIG. 3 illustrates an example of the multiple types of classification involved with the method shown in FIG. 2, where the above-mentioned classified albums are displayed on the display device 160 of the electronic device 100 (e.g., the multifunctional mobile phone). For brevity, similar descriptions for this embodiment are not repeated in detail here.

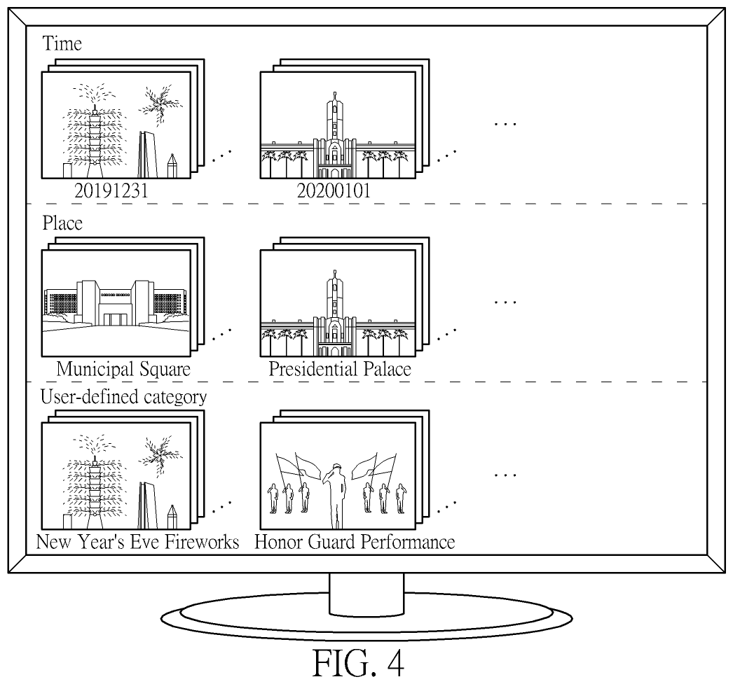

FIG. 4 illustrates another example of the multiple types of classification involved with the method shown in FIG. 2, where the above-mentioned classified albums are displayed on a display device of another electronic device (e.g., the above-mentioned other electronic devices such as the any typical personal computer). For brevity, similar descriptions for this embodiment are not repeated in detail here.

According to some embodiments, the processing circuit 110 may create the first set of directories (e.g., “/20191231”, “/20200101”, etc.), the second set of directories (e.g., “/Municipal Square”, “/Presidential Palace”, etc.), the third set of directories (e.g., “/New Year's Fireworks”, “/Honor Guard Performance”, etc.) under the root directory of the file system of the external storage device 200, but the present invention is not limited thereto. In some embodiments, the respective locations of the first set of directories, the second set of directories, the third set of directories, etc. may vary. In particular, the processing circuit 110 may respectively create the first set of directories, the second set of directories, the third set of directories, etc. under one or more layers of directories under the root directory. For example, the one or more layers of directories may represent a backup directory such as “/Backup”, and the first set of directories, the second set of directories, the third set of directories, etc. may be located under the backup directory. For another example, the one or more layers of directories may represent a set of backup directories corresponding to the multiple types of classification, such as “/time”, “/place”, “/user-defined category”, etc., and the first set of directories, the second set of directories, the third set of directories, etc. may be located under the set of backup directories (e.g., “/time”, “/place”, “/user-defined category”, etc.), respectively. For yet another example, the one or more layers of directories may comprise the backup directory and the set of backup directories, where the set of backup directories may be located under the backup directory, and the first set of directories, the second set of directories, the third set of directories, etc. may be located under the set of backup directories, respectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing album management regarding an external storage device for a user, the method being applicable to an electronic system, the electronic system comprising an electronic device and the external storage device, the external storage device being positioned outside of the electronic device and coupled to the electronic device as an accessory of the electronic device, the method comprising:
utilizing a processing circuit to control at least two stages of backup, to generate a plurality of classified albums respectively corresponding to multiple types of classification within the external storage device, wherein operations of the at least two stages of backup comprise:
regarding a first-stage backup, creating a first physical classified album among the plurality of classified albums according to a first type of classification index; and
regarding a second-stage backup, creating at least one other classified album among the plurality of classified albums according to at least one other type of classification index, wherein said at least one other classified album is different from the first physical classified album, and said at least one other classified album has reference information of at least one portion of pictures in the first physical classified album, to allow the user to directly browse all classified albums of the plurality of classified albums through an operating system.

2. The method of claim 1, further comprising:
utilizing the processing circuit to scan all pictures of multiple pictures in at least one internal storage device within the electronic device and analyze respective picture contents of the multiple pictures to perform classification, and establish an index database of each picture of the multiple pictures according to multiple classification tags respectively corresponding to the multiple types of classification, where the index database comprises one or more classification indexes of said each picture.

3. The method of claim 2, wherein the first physical classified album in the external storage device comprises respective backup pictures of the multiple pictures in the electronic device.

4. The method of claim 1, wherein any classified album of said at least one other classified album in the external storage device has reference information of one or more pictures in the first physical classified album to indicate the one or more pictures shared by said any classified album, to allow the user to directly browse all classified albums of the plurality of classified albums through the operating system.

5. The method of claim 1, wherein a file system of the external storage device is equipped with a hard link or soft link function; and the reference information of said at least one portion of pictures in the first physical classified album is generated based on said hard link or soft link function.

6. The method of claim 1, wherein a file system of the external storage device does is not equipped with a hard link or soft link function; and the reference information of said at least one portion of pictures in the first physical classified album is generated by changing an indicator of directory structure.

7. The method of claim 1, wherein any classified album in said at least one other classified album in the external storage device does not have a same file content as the first physical classified album.

8. The method of claim 1, wherein the multiple types of classification comprise at least two of time, place, event, person, and object.

9. The method of claim 1, wherein the first type of classification index corresponds to a first type of classification among the multiple types of classification, and said at least one other type of classification index corresponds to at least one other type of classification among the multiple types of classification.

10. An apparatus for performing album management regarding an external storage device for a user, the apparatus comprising:
an electronic device, comprising:
a processing circuit, configured to execute a program code to control operations of the electronic device;
at least one internal storage device, coupled to the processing circuit, configured to store information for the electronic device; and
an interface circuit, coupled to the processing circuit, configured to perform communications, wherein the external storage device is coupled to the electronic device through the interface circuit to be an accessory of the electronic device;
wherein:
the processing circuit controls at least two stages of backup, to generate a plurality of classified albums respectively corresponding to multiple types of classification within the external storage device, wherein operations of said at least two stages of backup comprise:
regarding a first-stage backup, creating a first physical classified album among the plurality of classified albums according to a first type of classification index; and
regarding a second-stage backup, creating at least one other classified album among the plurality of classified albums according to at least one other type of classification index, wherein said at least one other classified album is different from the first physical classified album, and said at least one other classified album has reference information of at least one portion of pictures in the first physical classified album, to allow the user to directly browse all classified albums of the plurality of classified albums through an operating system.
